(19) United States
(12) Patent Application Publication
(10) Pub. No.: US 2012/0118697 A1
(43) Pub. Date: May 17, 2012

(54) REMOTE MANAGEMENT OF A BILL VALIDATOR FOR A GAMING MACHINE

(75) Inventors: Andre Soussa, North Ryde (AU); Geoffrey Engel, North Ryde (AU)

(73) Assignee: GLOBAL PAYMENT TECHNOLOGIES AUSTRALIA, North Ryde (AU)

(21) Appl. No.: 13/293,966

(22) Filed: Nov. 10, 2011

(30) Foreign Application Priority Data
Nov. 12, 2010 (AU) 2010905019

(51) Int. Cl. G07D 7/02

(52) U.S. Cl. 194/302

(57) ABSTRACT

Described herein are systems and methods for providing interaction with a terminal. In overview, a validator for a terminal (such as a gaming machine or the like) includes a central processing unit, and a memory module coupled to the central processing unit, the memory module configured for maintaining software instructions that are executable via the central processing unit, and for maintaining diagnostic information concerning the validator. A primary communications port coupled to the central processing unit allows interaction between the validator and the terminal. A secondary communications port for allows communications between the validator and a handheld remote device, such that diagnostic information regarding the validator is able to be displayed via the handheld remote device. The handheld device executes corresponding software instructions to facilitate interaction with the validator.

### FIELD OF THE INVENTION

The present invention relates to a remote management of a bill validator for a gaming machine. Embodiments of the invention have been particularly developed for allowing technical personnel to retrieve diagnostic information from the validator and/or provide updates or instructions to the validator, and include the likes of software executable externally of the gaming machine and validator, along with validator software and hardware. While some embodiments will be described herein with particular reference to that application, it will be appreciated that the invention is not limited to such a field of use, and is applicable in broader contexts.

### BACKGROUND

Any discussion of the background art throughout the specification should in no way be considered as an admission that such art is widely known or forms part of common general knowledge in the field.

Various forms of terminals make use of validators for accepting payment (for example by way of currency notes). Examples include electronic gaming machines (such as poker machines or slot machines), vending machines (such as those used to dispense food and/or beverages), and banking machines (such as ATM machines).

In the context of gaming machines, there is often a need to retrieve diagnostic information regarding the validator, or otherwise interact with the validator (for example to provide a firmware/software update). For example, in the context of gaming machines, it is necessary to obtain information concerning the values of notes that have been accepted, and so on. This generally necessitates temporarily taking the gaming machine out of commission to access a machine diagnostic menu system, and retrieving the relevant information from that system.

There is a need in the art for improved validators and associated management infrastructure.

### SUMMARY OF THE INVENTION

It is an object of the present invention to overcome or ameliorate at least one of the disadvantages of the prior art, or to provide a useful alternative.

One embodiment provides a validator for operation with a terminal, the validator including:

a central processing unit;

a memory module coupled to the central processing unit, the memory module configured for maintaining software instructions that are executable via the central processing unit, and for maintaining diagnostic information concerning the validator;

a primary communications port coupled to the central processing unit, wherein the primary communications port is configured for coupling the validator to the terminal for allowing interaction between the validator and the terminal;

a secondary communications port for allowing the validator to communicate with a handheld remote device, such that diagnostic information regarding the validator is able to be displayed via the handheld remote device.

One embodiment provides a validator wherein the secondary communications port allows wireless communication between the validator and the handheld remote device.

One embodiment provides a validator wherein the validator is configured to provide an identification signal such that the validator is able to be uniquely identified by the handheld remote device.

One embodiment provides a validator wherein the identification signal is proximity sensitive.

One embodiment provides a validator wherein the identification signal is activated responsive to the validation of a predetermined token.

One embodiment provides a validator wherein the secondary communications port is activated responsive to the validation of a predetermined token.

One embodiment provides a validator wherein the identification signal is activated responsive to a manual interaction with the validator.

One embodiment provides a validator wherein the secondary communications port is activated responsive to a manual interaction with the validator.

One embodiment provides a validator wherein the wireless communication between the validator and the handheld remote device is via a networked intermediary device.

One embodiment provides a method for operating a gaming machine, the method being performed via software maintained on a handheld device, the method including:

providing a user interface on a display of the handheld device;

opening a communications channel with a validator that provides token validation for a gaming machine;

retrieving from the validator data indicative of validator diagnostic information; and

displaying the diagnostic information via the user interface.

One embodiment provides a method including:

providing, via the user interface, a selection interface for allowing a user to select one of a plurality of available validators.

One embodiment provides a method including:

receiving a signal from a particular validator, and determining to open the communications channel with that particular validator.

One embodiment provides a method wherein the validator includes a wireless network interface for allowing the opening of the communications channel.

One embodiment provides a method wherein the communication between the validator and the handheld remote device is via a networked intermediary device.

One embodiment provides a tangible computer readable carrier medium carrying computer executable code that, when executed by one or more processors of a handheld device, cause the handheld device to perform a method as described herein.

One embodiment provides a server maintaining data downloadable to a handheld device, wherein the data when downloaded and loaded to the handheld device configures the handheld device to perform a method as described herein to 14.

One embodiment provides a handheld device configured to perform a method as described herein.

One embodiment provides a computer implemented method including:

receiving data indicative of one or more identifiers representative of bill validators;

identifying, on a computer network, the bill validators of which the bill validators are representative; and

providing an interface for displaying diagnostic information obtained from the identified bill validators.

One embodiment provides a computer implemented method wherein each bill validator is maintained in a respective host machine, and wherein there is defined for each bill validator an inherent identifier indicative of a characteristic of the validator and a purposive identifier indicative of a characteristic of the host machine, thereby to allow unique identification of a particular validator based on the characteristic of the host machine.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

### BRIEF DESCRIPTION OF THE DRAWINGS

Preferred embodiments of the invention will now be described, by way of example only, with reference to the accompanying drawings in which:

FIG. 1 is a schematic representation of a validator and terminal according to one embodiment.

FIG. 2 is a schematic representation of a validator according to one embodiment.

FIG. 3 is a schematic representation of a validator and handheld device according to one embodiment.

FIG. 4 is a schematic representation of validator and terminal networks according to one embodiment.

### DETAILED DESCRIPTION

Described herein are systems and methods for providing interaction with a terminal. In overview, a validator for a terminal (such as a gaming machine or the like) includes a central processing unit, and a memory module coupled to the central processing unit, the memory module configured for maintaining software instructions that are executable via the central processing unit, and for maintaining diagnostic information concerning the validator. A primary communications port coupled to the central processing unit allows interaction between the validator and the terminal. For example, this is commonly achieved via a serial connection or the like. A secondary communications port for allows wireless communications between the validator and a remote device, such that diagnostic information regarding the validator is able to be displayed via the remote device. In some embodiments the remote device is a handheld device that executes corresponding software instructions to facilitate interaction with the validator.

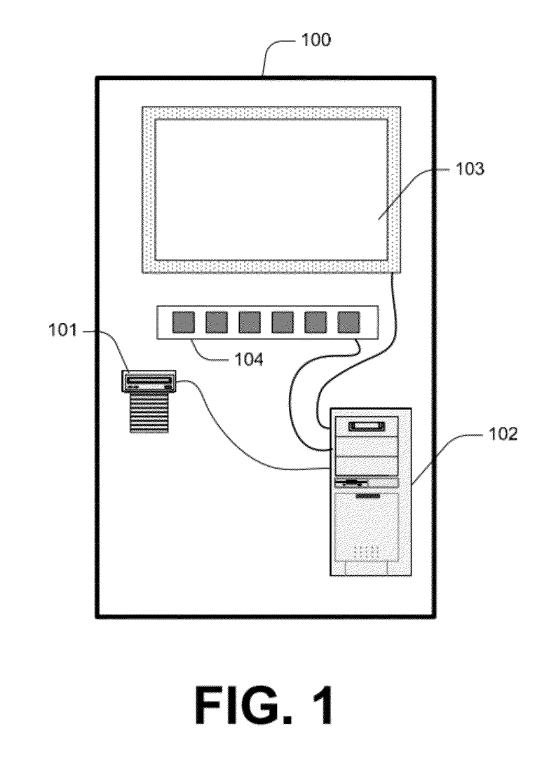

Referring initially to FIG. 1, the present embodiments are generally directed to situations where a terminal 100 is configured to operate with a validator 101. The term “validator” is used to describe a piece of hardware configured for accepting payment, such as payment in the form of currency notes. As such, it should be assumed that a validator includes an input aperture into which physical payment substrates (such as currency notes) are inserted, and components for reading/validating those payment substrates. Based on that reading/validation, the validator provides selectively (or inherently) a signal to the terminal. For example, if a currency note is validated, the signal informs the terminal in relation to that currency note. A validator is a standalone unit with respect to the terminal, having its own processing and memory components. It should be appreciated that the operation of a validator as described herein is by no means limited to core functionality of accepting payment. The present embodiments utilize an appreciation that a validator operates as a significant entry point for accessing terminal functionalities, and extend validator functionalities accordingly.

Various forms of terminal 100 make use of validators for accepting payment (for example by way of currency notes). Examples include electronic gaming machines (such as poker machines or slot machines), vending machines (such as those used to dispense food and/or beverages), and banking machines (such as ATM machines). The present embodiments should not be limited to any particular form of terminal, unless specifically stated otherwise. However, various the present embodiments are primarily directed towards terminals in the form of gaming machines. The exemplary terminal 100 of FIG. 1 includes a central control unit 102, which is coupled to validator 101. Control unit 102 is additionally coupled to a display 103 and input device 104. In some embodiments terminal 100 includes additional components (such as mechanical components in the context of vending machines).

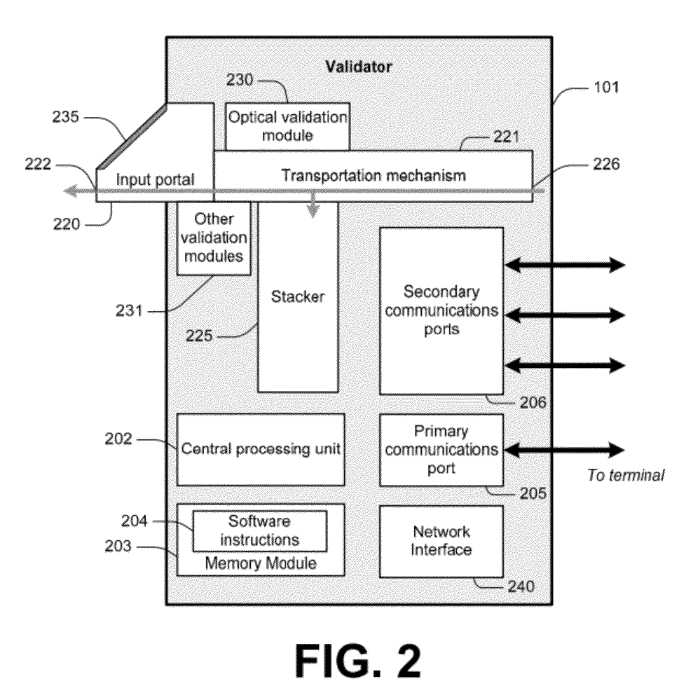

FIG. 2 illustrates a validator 101 according to one embodiment. This validator is adapted for operation with a terminal such as terminal 100. Validator 101 includes a central processing unit, referred to herein as processor 202. This may take the form of (or include) a general purpose microprocessor, or a plurality of microprocessors. A memory module 203 is coupled to processor 202. Memory module 203 is configured for maintaining software instructions 204 that are executable via processor 202. It will be appreciated that these software instructions (which presently include validator firmware) provide various functionalities to validator 101, some of which being described in detail further below.

Validator 101 includes a primary communications port 205 coupled to processor 202. The primary communications port is configured for coupling the validator to the terminal for allowing interaction between the validator and the terminal. The nature of port 205 varies between embodiments, and may include a serial connection port, USB port, or other form of connection.

Validator 101 additionally includes one or more secondary communications ports 206. These are also coupled to processor 202. The communications ports are configured for allowing connection of one or more peripheral components for allowing interaction between the validator and such components. Once again, the nature of ports 206 varies between embodiments, and may include a serial connection ports, USB ports, or other forms of connection. Peripheral devices may include the likes of printers, displays, other input/output devices, and so on. Although ports 206 are illustrated as being commonly located, this is by no means necessary.

An input portal 220 is coupled to processor 102. The input portal is configured for receiving multiple forms of token. At least one of the forms of token includes a physical substrate for providing payment, such as currency notes. Various other forms of token are discussed further below.

Validator 101 includes a transportation mechanism 221 coupled to the central processing unit. Mechanism 221 is also physically coupled to input portal 220 (or appropriately located relative to the input portal), thereby to allow tokens in the form of substrates (including substrates that carry tokens) to be passed from and to the input portal. A grey line with arrows indicates the passage of substrates. However, it will be appreciated that this is indicative only, given the schematic nature of the present diagrams.

In the present embodiment, validator 101 additionally includes a network interface 240 coupled to the central processing unit. This network interface allows the validator to communicate with a remote device, and/or participate in a validator network including a plurality of validators. Network interface 240 may include one or a plurality of individual network interfaces. Examples of network interfaces include GSM/GPRS modules, WiFi, wireless or wired Ethernet, Bluetooth, RF communications, and the like. In some embodiments network interface 240 is defined by a plurality of network interfaces.

In various of the present embodiments, network interface 240 allows validator 101 to wirelessly communicate with a remote device. Specifically, network interface 240 provides a secondary communications port for allowing the validator to communicate with a handheld device over a wireless communications channel, such that diagnostic information regarding the validator is able to be displayed via the remote device.

Embodiments described herein fall into two general categories:
(i) Proximal Machine Interaction: in such embodiments there is a desire to uniquely identify the validator of a physical machine whilst proximal that machine. For example, an operator carries a handheld remote device having a wireless network interface, and wishes to interact with a particular machine that is proximal the operator.
(ii) Validator network management: in such embodiments there is a desire to manage a plurality of validators in a venue via a common network to which the validators connect. An operator identifies a validator by characteristics of the validator or the host machine, as opposed to proximity based (e.g. visual) identification.

Both categories of embodiment are discussed further below. It will be appreciated that some devices in accordance with the current disclosure fall into both categories.

### Proximal Machine Interaction

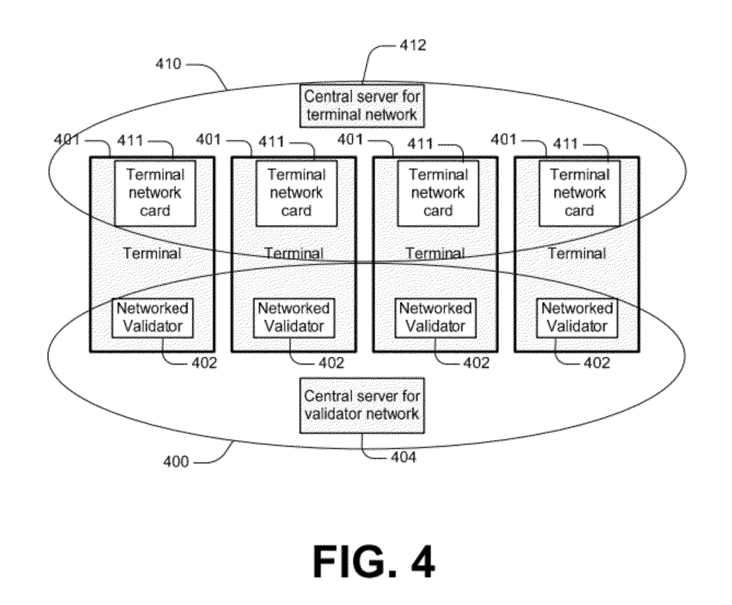

Although in some embodiments there is only a single validator in a given location, in other embodiments there are multiple validators (for example in the context of a gaming venue having numerous gaming machines). In such environments, there are challenges in terms of identifying a particular validator, given inherent challenges of wireless networking. A general objective is for an operator to be enabled to approach a given machine, and uniquely identify and wirelessly connect to the validator of that machine. Embodiments of the subject invention implement a number of varied approaches implemented to achieve this goal, for instance:
In some embodiments the validator is configured to provide an identification signal such that the validator is able to be uniquely identified by the handheld remote device. For example, each validator is configures to broadcast a respective identification signal to facilitate unique discovery, in some cases either via a network adaptor or via a short range radio transmission. One approach uses numerical identifiers, which may correspond to identifiers allocated to machines containing the validators (for example one electronic gaming machine is “machine 50” and another is “machine 51”). This identifier allows the handheld device to identify a desired validator.
In some embodiments a proximity sensitive signal is used, such that the handheld device only discovers a validator when within a predetermined proximity of that validator. For example, an 802.11 network adapter carried by a validator has its wireless radio tuned such that it is effective only over a short distance, defined by a zone proximal the host machine. That way, when an operator approaches a given machine, only that machine is discoverable. Directional radio antennas are also optionally used to achieve this general purpose.
In some cases an identification signal is activated responsive to the validation of a predetermined token. For example, the secondary communications port or identification signal may be activated responsive to the validation of a predetermined token. That is, a user inserts an administrator token into the validator, swipes a proximity card, presents a RFID-based token or so on, thereby to actuate the network interface for a predefined period thereby to enable validator discovery by the handheld device. This may also be achieved by other a manual interaction with the validator, such as pressing a button or the like.
In some cases the wireless communication between the validator and the handheld remote device is via a networked intermediary device. For example, a validator or terminal network such as those shown in FIG. 4 is used, and the handheld device connects to a server device that maintains data indicative of the validators/machines and their network addresses. In such an embodiment, the handheld device may display a selection interface for allowing a user to select one of a plurality of available validators (optionally being described by reference to the terminal in which they reside).
In some embodiments network adaptor unique characteristics (or other unique characteristics) are used to enable unique identification. For example, a sticker containing an identifier defined by or representative of a MAC address for the validator is printed and applied to the host machine. This is inputted manually into the handheld device thereby to permit unique identification (without a need to consult a central server or the like).

In some embodiments wireless interaction between a handheld device and a validator is achieved via software maintained on the handheld device. For example, one embodiment provides a method performed by a handheld device on the basis of such software, the method including providing a user interface on a display of the handheld device. For example, this user interface may be provided by a standalone application (such as an iPhone app or the like), or via a browser application that renders an interface made available by a web server. The method includes opening a communications channel with a validator that provides token validation for a gaming machine, such as that shown in FIG. 2. The handheld device interacts with the validator, for example in terms of retrieving from the validator data indicative of validator diagnostic information, such as the total value in tokens accepted and/or stacked, last token inserted, and so on. This diagnostic information is displayed via the user interface. The interaction may additionally/alternately be for the purposes of downloading data to the validator (such as a software/firmware update).

### Validator Network Management:

As noted, in such embodiments there is a desire to manage a plurality of validators in a venue via a common network to which the validators connect. An operator identifies a validator by characteristics of the validator or the host machine, as opposed to proximity based (e.g. visual) identification. In some such embodiments, a user interface provides (on a handheld a selection interface for allowing a user to select one of a plurality of available validators. In some embodiments, rather than using a selection interface, the handheld device receives a signal from a particular validator, and determining to open the communications channel with that particular validator.

In some embodiments, software executed at a remote terminal (which may be a handheld device) is configured to allow convenient management of a set of networked validators. In one embodiment, that software application is user-configured to be programmed with identifiers (preferably factory-defined identifiers) for the set of validators (which may be serial numbers, MAC addresses, or the like). A user of the software application is thereby able to interact (for example obtain diagnostic information from) any of the validators in the set. Preferably the identifiers for all validators at a venue are pre-configured to fall within a specific range, thereby to streamline the user-configuration of the software application. In some cases each validator has a factory-defined identifier which is able to be associated with a user-specified identifier, for example thereby to allow a user to associate each validator with an identifier corresponding to its host machine.

In this manner, one embodiment provides a computer implemented method, performable at a device such as a handheld device or a PC, the method including receiving data indicative of one or more identifiers representative of bill validators. Preferably each bill validator is maintained in a respective host machine (such as a gaming machine), and there is defined for each bill validator an inherent identifier indicative of a characteristic of the validator and a purposive identifier indicative of a characteristic of the host machine, thereby to allow unique identification of a particular validator based on the characteristic of the host machine. The method additionally includes identifying, on a computer network, the bill validators of which the bill validators are representative, and providing an interface for displaying diagnostic information obtained from the identified bill validators.

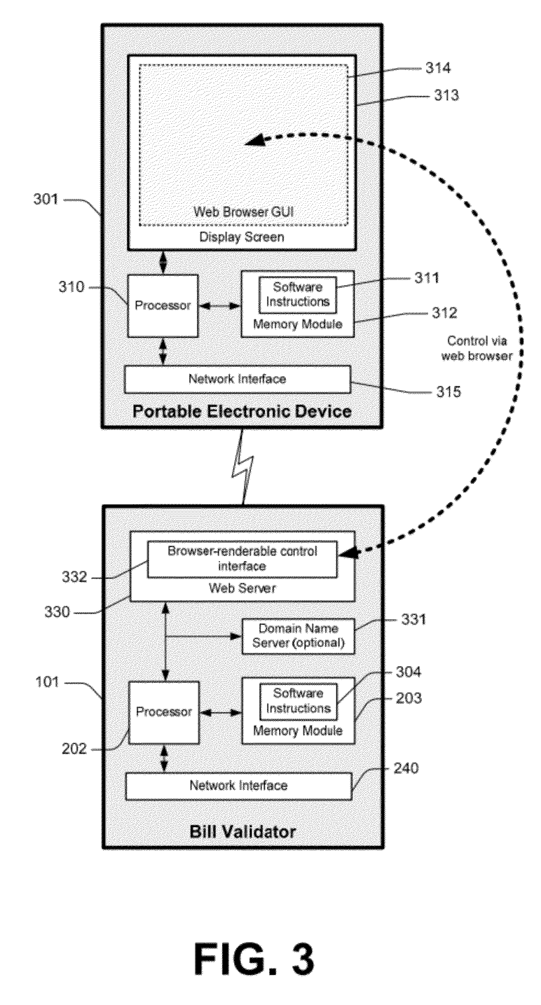

In the example of FIG. 3, a wireless web-enabled handheld device 301 interacts with a wireless network enabled validator 101. In overview, device 301 is used to access diagnostic information for control wireless validator 101, and in some cases provide configuration and/or control signals to the validator.

Device 301 includes a processor 310 coupled to a memory module 311, this memory module maintaining software instructions 312. Software instructions 312 allow processor 310 to execute a web browser application 313, schematically shown as a GUI on a display screen 314. Various web browser applications executable on portable devices are known, these generally including similar functionalities (for example the ability to render HTML content). Device 301 also includes an 802.11 type network interface 315, which may be substituted for any other suitable wireless communications interface for the purposes of alternate embodiments.

Validator 101 provides a web-server 320 and, in some embodiments, a domain name server 321. It will be appreciated that these are effectively processes provided by way of software instructions 113 executing on processor 113. Web server 320 makes available data indicative of a browser renderable control interface 322, including HTML data for allowing the rendering of one or more web pages by way of browser application 313.

As noted, the provision of a domain name server is optional. In some embodiments the wireless validator provides the only domain name server on the network. However, in many cases there will be an existing domain name server on the network. Often, it is often preferable to avoid the introduction of a further domain name server. However, some embodiments described herein make use of a domain name server in the validator itself to allow resolution of a predetermined control URI to the control interface provided by way of the validator's web server. Other embodiments make use of a remote server arrangement to achieve a similar goal.

In overview, the handheld device navigates to a web address describing validator 101, and in doing so is provided with a browser-rendered user interface for interacting with the validator. This may be an address such as www.validatoracces.com, or where validators are provided with identifiers in the form XX, www.validatorXX.com (i.e. each validator is configured to know its identifier, and adjust its web server functionality in response to that identifier).

It will be appreciated that the present approaches are not limited to browser-based user interfaces, and are equally applicable to standalone applications that execute on device 301.

An exemplary validator network 400 is schematically illustrated in FIG. 4, which shows a plurality of terminals 401 each having a respective validator 402, these being connected to form a validator network 403. The validator network additionally includes a central server 404, although this is not necessary in all cases. FIG. 4 additionally shows a terminal network 410. That is, each terminal 401 includes a respective network interface 411 that enables them to communicate with a central server 412 over network 410. Either of these networks may be used to provide a handheld device with a communications channel to access diagnostic information for a desired one of the validators.

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while some diagrams only show a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

Similarly it should be appreciated that in the above description of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A validator for operation with a terminal, the validator including:
a central processing unit;
a memory module coupled to the central processing unit, the memory module configured for maintaining software instructions that are executable via the central processing unit, and for maintaining diagnostic information concerning the validator;
a primary communications port coupled to the central processing unit, wherein the primary communications port is configured for coupling the validator to the terminal for allowing interaction between the validator and the terminal;
a secondary communications port for allowing the validator to wirelessly communicate with a handheld remote device, such that diagnostic information regarding the validator is able to be displayed via the handheld remote device.

2. A validator according to claim 1 wherein the validator is configured to provide an identification signal such that the validator is able to be uniquely identified by the handheld remote device.

3. A validator according to claim 2 wherein the identification signal is proximity sensitive.

4. A validator according to claim 2 wherein the identification signal is activated responsive to the validation of a predetermined token.

5. A validator according to claim 1 wherein the secondary communications port is activated responsive to the validation of a predetermined token.

6. A validator according to claim 2 wherein the identification signal is activated responsive to a manual interaction with the validator.

7. A validator according to claim 1 wherein the secondary communications port is activated responsive to a manual interaction with the validator.

8. A validator according to claim 1 wherein the wireless communication between the validator and the handheld remote device is via a networked intermediary device.

9. A validator according to claim 1 wherein the secondary communications port allows for download of data from the handheld remote device to the validator.

10. A method for operating a gaming machine, the method being performed via software maintained on a handheld device, the method including:
providing a user interface on a display of the handheld device;
opening a wireless communications channel with a validator that provides token validation for a gaming machine;
retrieving from the validator data indicative of validator diagnostic information; and
displaying the diagnostic information via the user interface.

11. A method according to claim 10 including:
providing, via the user interface, a selection interface for allowing a user to select one of a plurality of available validators.

12. A method according to claim 10 including:
receiving a signal from a particular validator, and determining to open the communications channel with that particular validator.

13. A method according to claim 10 wherein the validator includes a wireless network interface for allowing the opening of the communications channel.

14. A method according to claim 10 wherein the communication between the validator and the handheld remote device is via a networked intermediary device.

15. A method according to claim 10 wherein the software maintained on the handheld device enables unique discovery of the validator subject to a manual local interaction between an operator and the validator or a machine containing the validator.

16. A computer implemented method including:
receiving data indicative of one or more identifiers representative of bill validators;
identifying, on a computer network, the bill validators of which the bill validators are representative; and
providing an interface for displaying diagnostic information obtained from the identified bill validators.

17. A computer implemented method according to claim 16 wherein each bill validator is maintained in a respective host machine, and wherein there is defined for each bill validator an inherent identifier indicative of a characteristic of the validator and a purposive identifier indicative of a characteristic of the host machine, thereby to allow unique identification of a particular validator based on the characteristic of the host machine.
